(19) United States
(12) Patent Application Publication
(10) Pub. No.: US 2013/0115956 A1
(43) Pub. Date: May 9, 2013

(54) Location Based Radio Access System Selection

(71) Applicants: Joerg Christian Ewert, Aachen (DE); Ralf Keller, Wurselen (DE)

(72) Inventors: Joerg Christian Ewert, Aachen (DE); Ralf Keller, Wurselen (DE)

(73) Assignee: TELEFONAKTIEBOLAGET L M ERICSSON (PUBL), Stockholm (SE)

(21) Appl. No.: 13/642,914

(22) PCT Filed: Apr. 29, 2010
(86) PCT No.: PCT/EP2010/055803

§ 371 Date: Jan. 9, 2013

(51) Int. Cl. H04W 36/14

(52) U.S. Cl. CPC H04W 36/14
USPC 455/437; 455/438

(57) ABSTRACT

To improve use of available radio resources and to increase end user perception of delivered radio services according to the present invention there is provided a method of operating a radio access control station in a wireless communication environment supporting at least two radio access technologies (GSM, WCDMA, LTE, WLAN) for radio communication with a mobile station. Here, a preferred radio access system is determined on the basis of a radio coverage map (10) referenced by a mobile station location. Then, the mobile terminal is notified of the preferred radio access system for communication with the wireless communication environment.

### FIELD OF INVENTION

The present invention relates to a method of location based radio access system selection, a related radio access control node, and a related mobile station.

### BACKGROUND OF INVENTION

In the future mobile stations will be operated in mobile communication environments supporting different radio access technologies.

Examples for such radio access technologies are, e.g., GSM operated at a frequency band of 450 MHz, LTE operated at a frequency band of 790-862 MHz, GSM operated at a frequency band of 900 MHz or 1800/1900 MHz, WCDMA operated at a frequency band of 2.1 GHz, LTE operated at a frequency band of 2.5 to 2.6 GHz, and/or WLAN operated at a frequency band of 2.4 to 5.4 GHz. Further realistic scenarios are combinations of such radio access technologies in any appropriate form.

Today technologies exist to perform handover from one radio access system to another, as described, e.g., in 3GPP specifications TS 23.060, TS 23.216, TS 23.401 and/or TS 23.402. These handover systems are based on measurement of a signalling strength which varies strongly according to a position of a mobile station. This may result in frequent handovers between different radio access systems, e.g., according to 2G and 3G.

One consequence with respect to available solutions is that end users often turn off 3G WODMA based services and only use 2G GSM services or that operators force voice calls into 2G GSM networks, so-called service based handover.

Further, according to 3GPP TS 23.237 and TS 23.292 operator preferences for radio access systems are used to inform a mobile station to change or maintain a particular radio access system when a mobile station can use more than one radio access system at a time. E.g., a mobile station may change from a first radio access system to a second radio access system in case the second radio access system is preferred by the network operator for the current operative state.

However, the existing handover mechanisms between different radio access systems result in dissatisfying results in delivery of radio communication services to mobile stations in wireless communication environments.

### SUMMARY OF INVENTION

In view of the above, a technical problem of the present invention is to improve use of available radio resources and to increase end user perception of delivered radio services.

To solve this technical problem, according to a first aspect of the present invention there is provided a method of operating a radio access control station in a wireless communication environment supporting at least two radio access technologies for radio communication with a mobile station. The method according to the first aspect of the present invention comprises the steps of determining a preferred radio access system on the basis of a radio coverage map referenced by a mobile station location and notifying the mobile terminal of the preferred radio access system for communication with the wireless communication environment.

Further, according to a second aspect of the present invention there is provided a method of operating a mobile station for radio communication with a wireless communication environment supporting at least two radio access technologies. The method according to the second aspect of the present invention comprises the steps of determining a preferred radio access system on the basis of a radio coverage map referenced by a mobile station location and switching to the preferred radio access system for radio communication with the wireless communication environment.

Further, according to a third aspect of the present invention there is provided a radio access control station operated in a wireless communication environment supporting at least two radio access technologies for radio communication with a mobile station. The radio access control station comprises a first radio access system determining unit adapted to determine a preferred radio access system on the basis of a radio coverage map referenced by a mobile station location, and a radio access system notifying unit adapted to notify the mobile terminal of the preferred radio access system for communication with the wireless communication environment.

Further, according to a fourth aspect of the present invention there is provided a mobile station for executing radio communication with a wireless communication environment supporting at least two radio access technologies. The mobile station comprises a second radio access system determining unit adapted to determine a preferred radio access system on the basis of a radio coverage map referenced by a mobile station location, and a radio access system switching unit adapted to switch to the preferred radio access system for radio communication with the wireless communication environment.

### DESCRIPTION OF DRAWINGS

In the following, preferred embodiments of the present invention will be described with reference to the drawing in which

FIG. 1 shows an example of a radio coverage map used for a location based selection of a preferred radio access system for radio communication between a mobile station and a radio access control node operated in a radio access or core network of a wireless communication environment;

FIG. 2 shows an example of a location based selection of a preferred radio access system with respect to a building and related change of radio availability when entering the building;

FIG. 3 shows a schematic diagram of a radio access control station according to the present invention;

FIG. 4 shows a schematic diagram of a mobile station according to the present invention;

FIG. 5 shows a flowchart of operation for determination of a preferred radio access system according to the present invention;

FIG. 6 shows a flowchart of operation for an alternative determination of a preferred radio access system according to the present invention;

FIG. 7 shows a flowchart of operation for yet another alternative determination of a preferred radio access system according to the present invention;

FIG. 8 shows a detailed schematic diagram of the map maintenance unit shown in FIG. 3; and

FIG. 9 shows a flowchart of operation for the map maintenance unit shown in FIG. 8.

### DESCRIPTION OF PREFERRED EMBODIMENTS

In the following, preferred embodiments of the present invention will be described with reference to the drawing. It should be noted that insofar specific functionality is described this functionality may be implemented in software or hardware or a combination thereof.

Further, the term radio access control station used in the following covers any network component in the radio access network or core network having the potential to implement the location based radio access system selection, e.g., a base station BS, a radio network controller RNC, a mobile switching centre MSC/VLR, a home location register HLR, a gateway GMSC to the wireless communication environment, etc.

Still further, the term radio access system to be used in the following covers any technology and infrastructure to establish a communication between a mobile station and a radio access network, e.g., according to GSM, WCDMA, LTE, WLAN, TD-SCDMA, etc.

According to the present invention as explained in the following mobile operators have the possibility to define preferred radio access systems as a function of a location of a mobile station, i.e., a mobile phone, a PAD, a mobile computer, etc. This allows the radio network operators to use available frequency bands more efficiently, to reduce the number of handovers, and to improve user perceptions of the network quality.

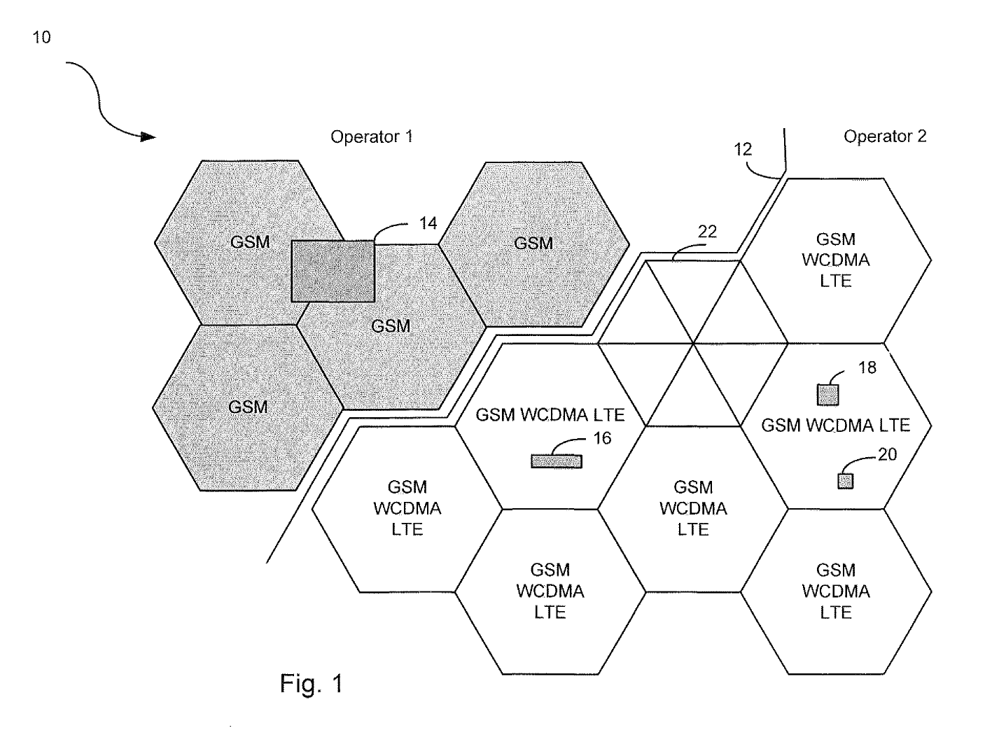

FIG. 1 shows an example of a radio coverage map used for a location based selection of a preferred radio access system for radio communication between a mobile station and a radio access control node operated in a radio access or core network of a wireless communication environment.

As shown in FIG. 1, generally a radio coverage map 10 is used for identifying a radio access system that is best suited to a current location of a mobile station communicating with a wireless communication environment supporting a plurality of radio access technologies.

As shown in FIG. 1, in the most general understanding according to the present invention a wireless communication environment may comprise different wireless communication networks operated, e.g., by a first network operator with respect to a first radio access technology, e.g., GSM, and a second network operator with respect to further radio access technologies GSM, WCDMA, LTE and separated by a border line 12.

As shown in FIG. 1, the radio coverage map 10 according to the present invention may serve to identify different buildings 14, 16, 18, 20 which need particular consideration with respect to radio coverage. Here, it may be beneficial to use technologies allocated to lower frequency bands for indoor coverage, e.g., GSM 900 MHz as such lower frequency bands are less sensitive to shadowing by buildings walls constructed of, e.g., concrete.

As also shown in FIG. 1, the radio coverage map 10 according to the present invention may serve to identify different sectors in a particular radio cell 22 so as to achieve radio access differentiation with respect to radio cell sectors, if necessary.

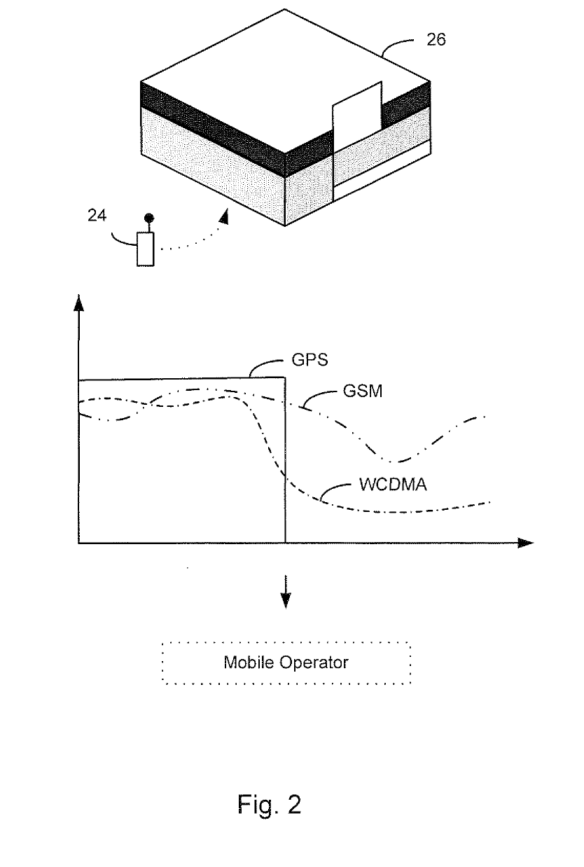

FIG. 2 shows an example of a location based selection of a preferred radio access system with respect to a building and related change of radio availability when entering the building.

As shown in FIG. 2, when a mobile station 24 approaches a building 26 radio availability at the mobile station 24 changes. To be more specific, signal strengths of radio signals received at the mobile station 24 change.

Here it should be noted that according to the present invention any type of radio signal may be incorporated into the selection process for the radio access system, e.g., according to radio signals being exchanged for radio communication either on the control level or on the traffic level according to GSM or WCDMA or according to radio signals used for position services like GPS.

As shown in FIG. 2, changes in the signalling strength of different radio signals may be used to identify, e.g. the border of a building 26 during service delivery but also when preparing the radio coverage map 10 shown in FIG. 1. The quality of such a decision may be enhanced by including measurements according to multiple radio access technologies from multiple mobile stations.

Using the radio coverage map 10 an operator has detailed information at which location the building 26 is located so that the operator may differentiate between indoor and outdoor coverage for individual users, for user groups, or for all users.

The radio access control node in the wireless communication environment will instruct the mobile station 24 with the information that it is now entering the building 26. E.g., then an existing handover mechanism may be disabled and a radio technology being preferred in the building 26 may be used. In general, it is also possible to use a list of preferred radio access systems implying a priority order according to the ranking on the list.

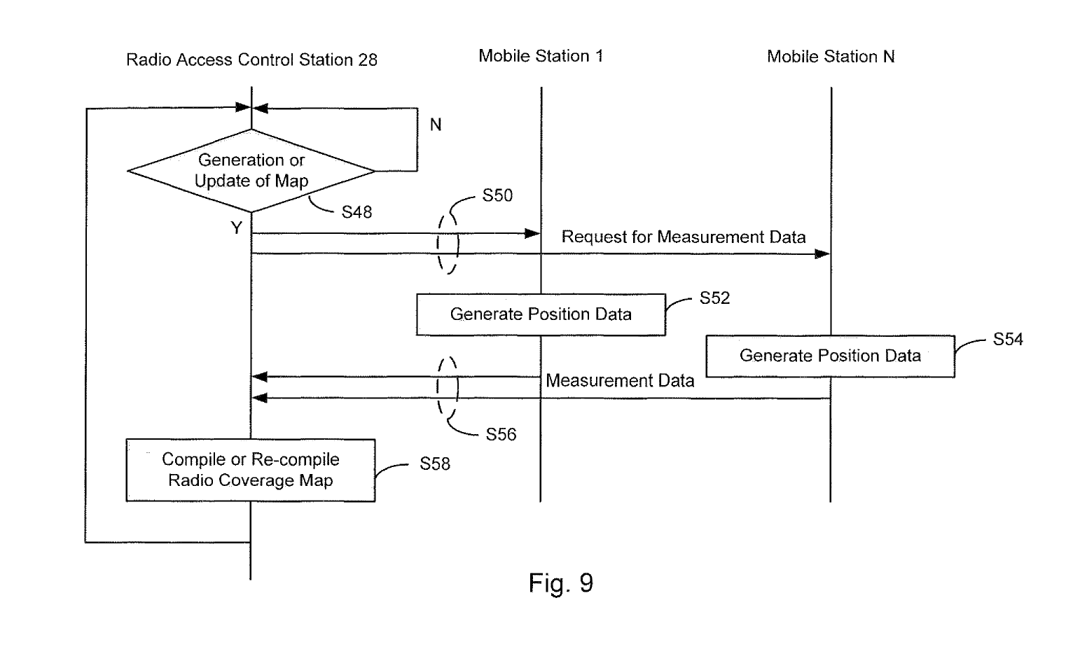

As shown in FIG. 2 and explained in more detail with respect to FIG. 9, one or more mobile operators may use the information provided by at least one mobile station 24. Here, it should not be stored by which mobile station a measurement has been performed.

In the following more details of the present invention will be explained with respect to structure and functionality of the wireless communication environment and the mobile station 24.

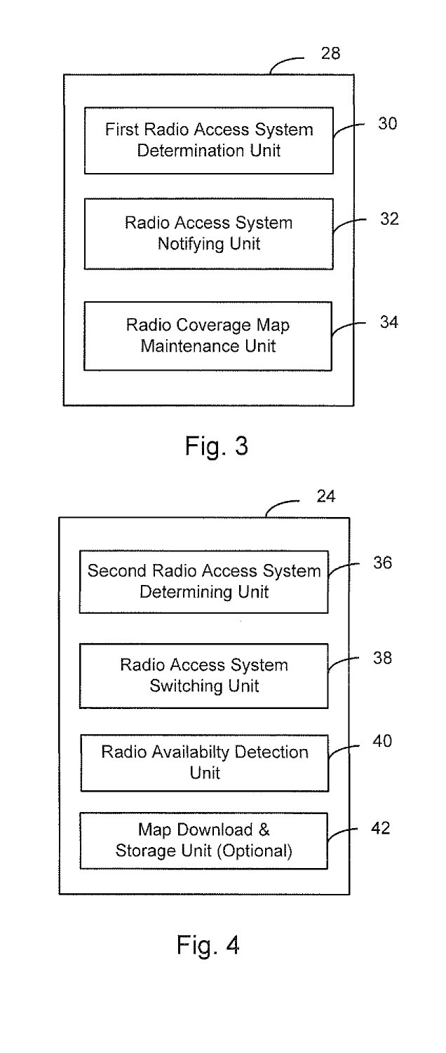

FIG. 3 shows a schematic diagram of a radio access control station 28 according to the present invention.

As shown in FIG. 3, the radio access control station 28 is operated in a wireless communication environment supporting at least two radio access technologies for radio communication with a mobile station 24 according to the present invention.

As shown in FIG. 3, the radio access control station 28 comprises a first radio access system determination unit 30, a radio access system notification unit 32, and a map maintenance unit 34.

Operatively, the first radio access system determination unit 30 is adapted to determine a preferred radio access system on the basis of the radio coverage map 10 shown in FIG. 1 as referenced by a mobile station location.

Here, reference by a mobile station location according to the present invention may mean the use of, e.g., GPS location information provided for a specific mobile station under consideration. Otherwise, location information may be provided in an indirect manner, e.g., through use of a cell ID for a wireless communication network cell where a mobile station is currently located. Another indication of location information could be, e.g., mobile station location information indicating that a mobile station is located inside or outside a specific building 26.

Further, the determination of the preferred radio access system is triggered by application of criteria, e.g. indoor or outdoor coverage. Other criteria could be used like bandwidth demand, historical information on user profile, i.e. if the user uses only voice or also using packet data, further network occupation and/or network status, e.g. if the network is in maintenance or not.

While above with respect to FIG. 2 an example has been explained where the mobile station 24 enters a building the mobile operator could instruct a preferred radio access system when the mobile station 24 is leaving the building again.

Further to the above, operatively the radio access system notification unit 32 is adapted to notify the mobile station on the preferred radio access system for communication with the wireless communication environment.

Further, operatively the radio coverage map maintenance unit 34 is adapted to generate and maintain the radio coverage map 10 as discussed above with respect to FIG. 1.

FIG. 4 shows a schematic diagram of a mobile station for executing radio communication with a wireless communication environment supporting at least two radio access technologies according to the present invention.

As shown in FIG. 4, the mobile station 24 according to the present invention comprises a second radio access system determination unit 34, a radio access system switching unit 36, a radio availability detection unit 40, and optionally a radio coverage map download and storage unit 42.

Operatively, the second radio access system determination unit 34 is adapted to determine a preferred radio access system on the basis of the radio coverage map 10 referenced by a mobile station location. Here it should be noted that the second radio access system determination unit 34 may determine the preferred radio access system either through invocation of a related functionality implemented in the wireless communication environment or autonomously at the mobile station 24 without interaction with the wireless communication system, as will be explained in more detail in the following.

Further, the second radio access system switching unit 36 is adapted to switch to the determined preferred radio access system for radio communication with the wireless communication environment.

Further, the radio availability detection unit 40 is adapted to detect the change of radio availability at the mobile station through drop in signal strength of a radio signal or through change of the types of radio signals receivable at the mobile station.

Further, the radio coverage map download and storage unit 42 is adapted to download and store the radio coverage map 10 from the wireless communication network prior to service delivery for autonomous determination of the preferred radio access system at the mobile station 24.

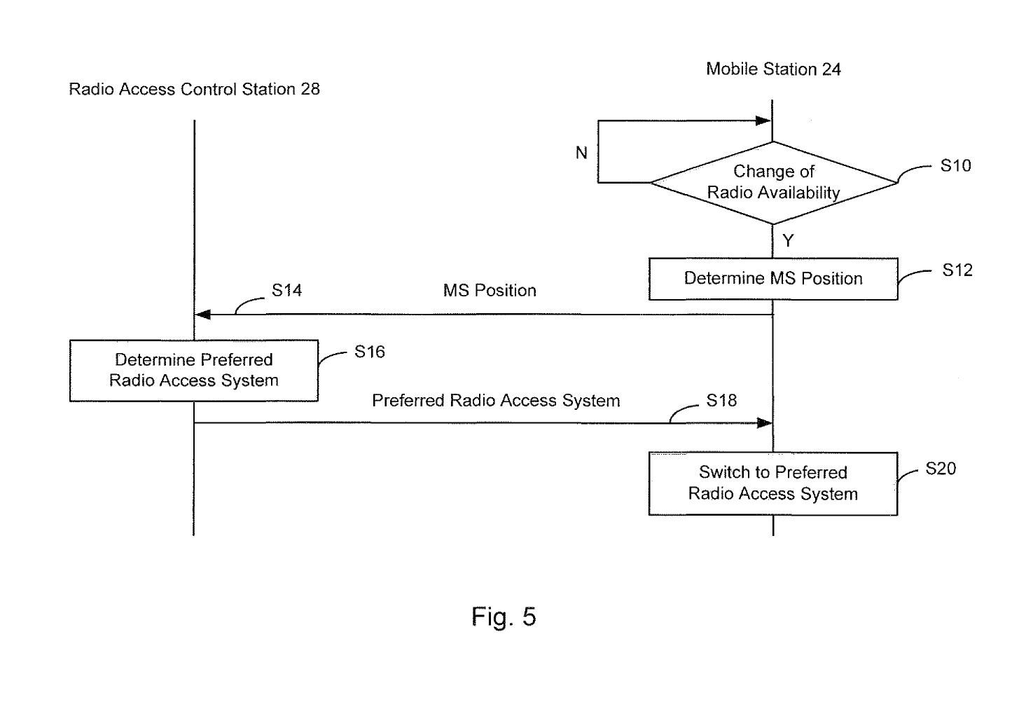

FIG. 5 shows a flowchart of operation for determination of a preferred radio access system according to the present invention.

As shown in FIG. 5, in a step S10 a change of radio availability is determined at the mobile station 24. Typically such a change of radio availability is measured considering signal strengths of either radio control signals or radio traffic signals at the mobile station, e.g., according to different standards. Another example would be that certain types of radio signals, e.g. according to GPS, are no longer available once the mobile station enters a certain operative status, e.g., enters a building.

As shown in FIG. 5, following the step S10 there is executed a step S12 to determine the position of the mobile station 24. Here it should be noted that the present invention is not restricted to any type of determination of location information. E.g., the location information may already be available at the mobile station 24 and simply be read out from a location buffer for forwarding thereof to the wireless network environment. As alternative the location information may be determined through satellite navigation using, e.g., GPS as an example. Yet another example would be to use cell ID as approximation to location information.

As shown in FIG. 5, after forwarding of at least some type of location information from the mobile station 24 to the radio access control station 28 in a step S14 the inventive process then continues with a step S16 to determine the preferred radio access system.

Preferably, in the step S16 the preferred radio access system is determined according to at least one criteria selected from a group comprising consideration of different radio coverage areas as reflected by the radio coverage map, consideration of a user profile reflecting user preferences, consideration of occupation of the wireless communication environment, and/or consideration of status of the wireless communication environment.

As shown in FIG. 5, in a step S18 the determined preferred radio access system is forwarded to the mobile station 24. Then, in a step S20 the mobile station 24 switches to the notified preferred radio access system.

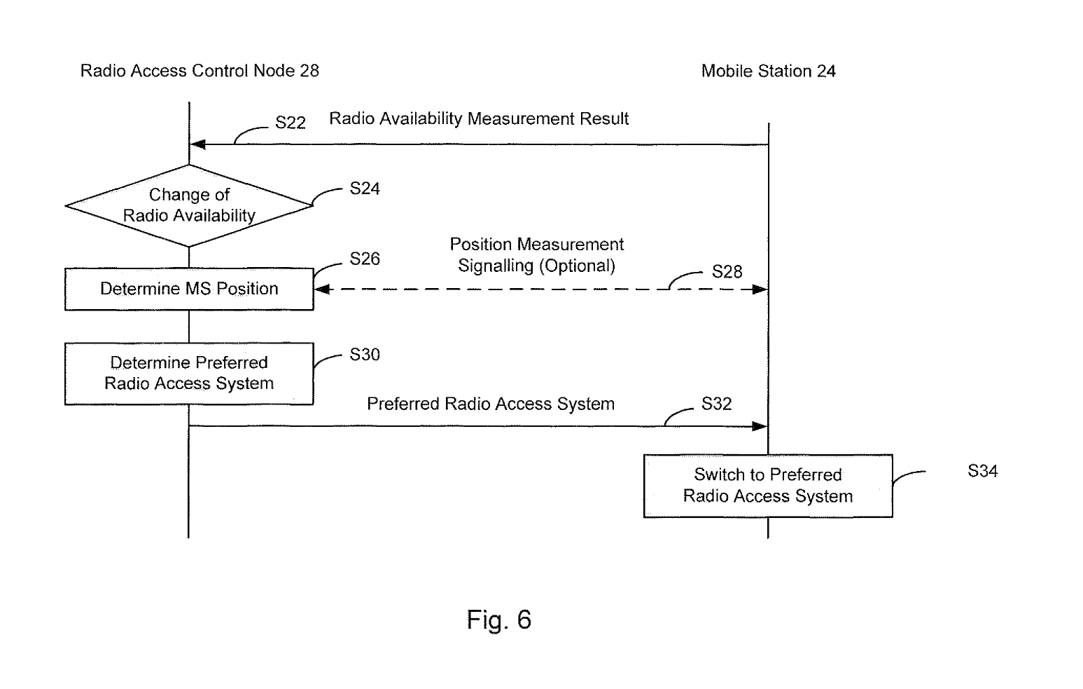

FIG. 6 shows a flowchart of operation for an alternative determination of a preferred radio access system according to the present invention. The alternative determination of the preferred radio access system reduces the processing load at the mobile station side.

As shown in FIG. 6, according to the alternative determination of the preferred radio access system there is executed a step S22 at an appropriate timing by the mobile station 24 to forward information allowing for evaluation of radio availability at the radio access control node 28. Here, the appropriate timing may be, e.g., periodical, according to a change of signal strength at the mobile station, or upon occurrence of new types of radio signals, e.g., occurrence of GPS signals when leaving a building, etc.

As shown in FIG. 6, the radio access control node 28 executes a step S24 to decide on a change of radio availability at the mobile station side. This step S24 may again be executed according to a predetermined timing, e.g., as explained with respect to the executing of step S22.

As shown in FIG. 6, a further-optional-step S26 serves for the determination of location information with respect to the mobile station 24. This may either be achieved through exchange of position measurement signalling in a step S28 as a first option. A further option for implementing the step S26 could be the processing of location related measurement information previously uploaded to the radio access control station 28.

As shown in FIG. 6, the alternative embodiment for radio access system selection then continues with a step S30 to determine the preferred radio access system. Here, it should be noted that the determination of the preferred radio access control system in step S30 is executed along the same line as outlined above with respect to step S16 shown in FIG. 5 so that the explanation thereof will not be repeated here.

As shown in FIG. 6, in a step S32 the determined preferred radio access system is forwarded to the mobile station 24. Then, in a step S34 the mobile station 24 switches to the notified preferred radio access system.

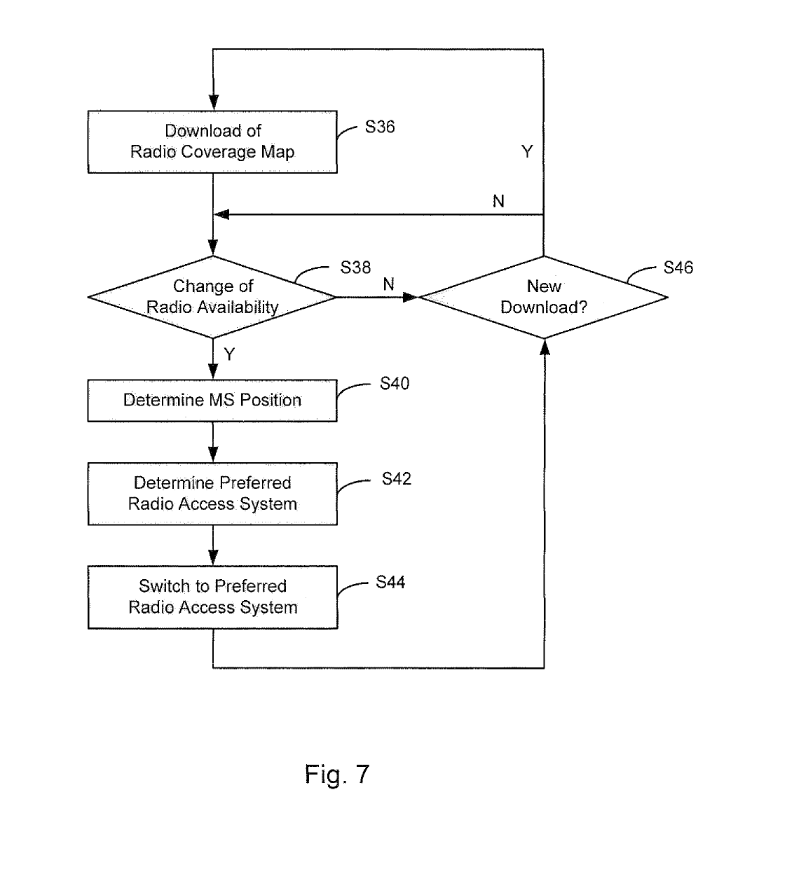

FIG. 7 shows a flowchart of operation for yet another alternative determination of a preferred radio access system according to the present invention. This additional alternative for the determination of the preferred radio access system aims at autonomous operation of the mobile station 24 while minimizing interaction with the radio access control node 28.

As shown in FIG. 7, initially the mobile station 24 executes a step S36 to download the radio coverage map from the wireless communication environment. Such download may be executed according to a predetermined timing, e.g., in a periodic manner or when receiving a related trigger from the wireless communication environment. Further, the download in step S36 may be executed in a push type manner according to at least one predetermined operative condition or in a pull type manner upon request from the mobile station. Still further, the download in step S36 may be executed to download the radio coverage map from the wireless communication environment executed with respect to a sub-area of the radio coverage area of the wireless communication environment.

In view of the above, the mobile station 24 receives the radio coverage information from the wireless communication environment in one of the following ways:
The mobile station requests the information from the wireless communication environment about a particular area, i.e. when entering an area for which it does not have up-to-date information or when, e.g., GPS connectivity as indication of an indoor case.
The wireless communication environment provides the information to the mobile station 24 when the mobile station 24 reports measurement results, i.e., in push or pull type manner, as described above.
The mobile station subscribes to changes of the radio coverage data and is automatically informed when new information is available, e.g., when the user only wants the information for his home or his enterprise.

As shown in FIG. 7, subsequent to the download of the radio coverage map in step S36 there is again executed a step S38 to determine a change of radio availability at the mobile station 24. Then, step S40 is executed to determine the position of the mobile station 24. It should be noted that the step S40 may be executed at any timing which is appropriate, i.e., also prior to determination of change of radio availability in step S38.

As shown in FIG. 7, upon change of radio availability there is executed a step S42 for determination of a preferred radio access system. It should be noted that the determination of the preferred radio access system is similar to steps S16 or S30 explained with respect to FIG. 5 or 6, respectively, so that related explanation will not be repeated here.

As an alternative the mobile station 24 may present radio coverage information to an end user in the form of a map or an indication of, e.g. “current preferred indoor access is RAN” for determination of the preferred radio access system by the end user.

As shown in FIG. 7, following step S42 there is executed a step S44 to switch to the determined preferred radio access system.

As shown in FIG. 7, in addition to the above there may be executed a step S46 to evaluate necessity of a repetition of the download of the radio coverage map. If so, the step S36 shown in FIG. 7 is repeated and otherwise the process branches off to step S38 for evaluation of a change of radio availability.

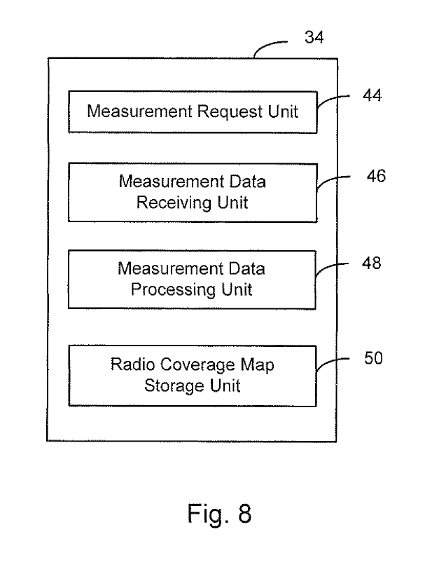

FIG. 8 shows a detailed schematic diagram of the map maintenance unit 34 shown in FIG. 3.

As shown in FIG. 8, the map maintenance unit 34 comprises a measurement request unit 44, a measurement data receiving unit 46, a measurement data processing unit 48, and a radio coverage map storage unit 50.

Operatively, the measurement request unit 44 is adapted to submit a request for provision of radio coverage measurement data to at least one mobile station 24 operated in the wireless communication environment. Here, it should be noted that the timing for submission of such measurement request may be determined as appropriate, e.g., in a periodic manner, upon reconfiguration of the wireless communication environment, dependent upon the traffic load in the wireless communication environment, etc.

Operatively, a measurement data receiving unit 46 is adapted to receive radio coverage measurement data from the at least one mobile station 24 operated in the wireless communication environment. Here, it should be noted that also the timing for the receipt of the measurement data may be determined as appropriate, e.g., according to traffic load by using a period of low load for transfer of measurement data.

Operatively, the measurement data processing unit 48 is adapted to process the received measurement data.

In more detail, the measurement data processing unit 48 is adapted to determine the radio coverage map 10 by receiving measurement data indicating signalling strength of at least one radio communication signal at the mobile station 24 and/or signalling strength of a positioning radio signal at the mobile station 24, and qualifying the received measurement data according to predetermined criteria.

Further, the measurement data processing unit 48 is adapted to qualify the received measurement data and may rely on receipt of multiple reports with respect to a same location in the wireless communication environment.

One option for qualification would be that the measurement data is information about available radio access systems and information on related signals strengths. Here, the latter information does not need to be in radio terms, i.e. information coded to be understood by the mobile station 24 or the radio access control station 28 only. To the contrary it could also be, e.g., “strong”, “average”, or “weak”. Here the mapping from the measurement data to these terms for qualification of measurement data could be done either in the mobile station 24 or in the radio access control station 28.

Further, regarding the differentiation between indoor and outdoor coverage the qualification of measurement data by the measurement data processing unit 48 may be explained as follows.

Already today mobile stations like mobile phones are equipped with multiple radio access technologies as outlined above, e.g., GSM, WCDMA, WLAN, LTE. Further, there is an ongoing trend to include GPS receivers in mobile phones.

In view of this, one way to qualify measurement data for derivation of a radio coverage map 10 of, e.g., building locations is that the mobile phones continuously measure the signalling strengths of the wireless communication networks and the signalling strength of the GPS receiver. It should be noted that the mobile station performs signalling strength measurement in radio cells in regular intervals anyway.

Here, a sharp drop in the signalling strength of one radio technology or of GPS can be considered as an indication that a building was entered. However, such a sharp drop may also be due, e.g., to a shadowing with respect to other buildings although especially in cities the operators plan their radio networks to minimize out of coverage operative states outside of buildings.

Here, the use of GPS data facilitates the differentiation between indoor and outdoor scenarios. E.g., a coverage loss of WCDMA can be rated as outdoor loss if one or more GPS satellites are still visible. Vice versa, it can be stated as an indoor case when the mobile station cannot see any GPS satellite but still has, e.g., GSM coverage.

Further, different levels of accuracy can be defined, forming a threshold to qualify the measurement of data. For GPS such a qualification may be as follows:
Three or more satellites are visible: perfect outdoor.
One or two satellites: weak, i.e. could be indoor or outdoor, e.g., close to windows.
No satellites visible: likely indoor.

Further, for GSM, WCDMA; LTE such a qualification may be as follows:
Multiple technologies, same cell: stable radio.
Move from multiple to single technology, optionally different cell ID and Location Area Code: possible move form indoor to outdoor.
Move from single technology to multiple technology, optionally different cell ID and Location Area Code: move from indoor to outdoor.
Single technology only: if no satellites are visible, likely indoor.

In case the operator already has street and building maps available, e.g., as used in navigation systems, the accuracy of, e.g., A-GPS is good enough to clearly differentiate indoor cases from outdoor cases. Also the principle of multiple reports may be applied such that more than one report is necessary to justify to use the measured data for setup of the radio coverage map 10.

Also, the network operator may instruct the mobile station to report, besides the above-mentioned data, also a cell ID and/or other cell identifiers, e.g., ESSID in the case of a WLAN. It should be noted that the ESSID may be reported also if a WLAN is not used and WLANS are used mainly inside and around buildings. Also, cell ID values are known by the operators; the same is true in case a WLAN is deployed by the operator.

Yet another variation of data collection and qualification is that the mobile station activates and deactivates radio based on information provided by the wireless communication environment, which is good for power saving. E.g., the mobile station 24 should activate the WLAN when entering the building 26 or, to be more general, when entering a pre-determined sub-area of the radio coverage area.

Further to the above operatively, the radio coverage map storage unit 50 shown in FIG. 8 is adapted to store the processing result generated by the measurement data processing unit 48.

FIG. 9 shows a flowchart of operation of the map maintenance unit 34 shown in FIG. 8. In particular, FIG. 9 illustrates the principle of multiple reports and radio coverage re-compilation underlying the present invention.

As shown in FIG. 9, the map maintenance unit 34 of the radio access control station 28 executes a step S48 to evaluate necessity of preparing a radio coverage map 10 or the necessity of an update thereof. A reason for such a necessity may be the installation of new wireless communication components in hardware or in software, a reconfiguration of the wireless communication environment, change of operative conditions in the wireless communication environment, etc.

As shown in FIG. 9, in a step S50 a multitude of mobile stations are requested to provide measurement data which is then generated at the mobile stations, e.g., in steps S52, S54. Then, the generated measurement data is uploaded to the radio access control node in a step S56, followed by a compilation or re-compilation of the radio coverage map in a step S58.

In an advanced mode to the operation shown in FIG. 9 the network operator could instruct mobile stations in certain locations to perform measurements and report results. Once the operator has sufficient data, the mobile stations are instructed to stop the additional measurement and the reporting.

Here it should be noted that according to the present invention the principle of multiple reports relies. I.e., with respect to one specific location it is preferable to have a plurality of measurement data for increase of precision and reliability.

In conclusion, according to a first aspect of the present invention there is provided a method of operating a radio access control station in a wireless communication environment supporting at least two radio access technologies for radio communication with a mobile station. The method according to the first aspect of the present invention comprises the steps of determining a preferred radio access system on the basis of a radio coverage map referenced by a mobile station location and notifying the mobile terminal of the preferred radio access system for communication with the wireless communication environment.

Further, according to a second aspect of the present invention there is provided a method of operating a mobile station for radio communication with a wireless communication environment supporting at least two radio access technologies. The method according to the second aspect comprises the steps of determining a preferred radio access system on the basis of a radio coverage map referenced by a mobile station location and switching to the preferred radio access system for radio communication with the wireless communication environment.

Further, according to a third aspect of the present invention there is provided a radio access control station operated in a wireless communication environment supporting at least two radio access technologies for radio communication with a mobile station. The radio access control station comprises a first radio access system determining unit adapted to determine a preferred radio access system on the basis of a radio coverage map referenced by a mobile station location, and a radio access system notifying unit adapted to notify the mobile terminal of the preferred radio access system for communication with the wireless communication environment.

Preferably, in the radio access control station according to the third aspect of the present invention the first radio access system determining unit is adapted to determine the preferred radio access system upon change of radio availability at the mobile station.

Preferably, in the radio access control station according to the third aspect of the present invention the change of radio availability at the mobile station is detected through drop in signal strength of at least one radio communication signal and/or at least one radio positioning signal or through change of the type of radio signals receivable at the mobile station.

Preferably, in the radio access control station according to the third aspect of the present invention the radio access system determining unit is adapted to determine the preferred radio access system according to at least one criteria selected from a group comprising consideration of different radio coverage areas as reflected by the radio coverage map, consideration of a user profile reflecting user preferences, consideration of occupation of the wireless communication environment, and/or consideration of status of the wireless communication environment.

Preferably, the radio access control station according to the third aspect of the present invention comprises a map maintenance unit adapted to determine the radio coverage map at the radio access control station by receiving measurement data from at least one mobile station indicating signalling strength of at least one radio communication signal at the mobile station and/or signalling strength of a positioning radio signal at the mobile station, and qualifying the received measurement data according to predetermined criteria.

Preferably, in the radio access control station according to the third aspect of the present invention the map maintenance unit is adapted to qualify the received measurement data and relies on receipt of multiple reports with respect to the same location in the wireless communication environment.

Preferably, in the radio access control station according to the third aspect of the present invention the measurement data received from at least one mobile station is generated on request of the radio access control station.

Further, according to a fourth aspect of the present invention there has been described a mobile station for executing radio communication with a wireless communication environment supporting at least two radio access technologies. The mobile station according to the present invention comprises a second radio access system determining unit adapted to determine a preferred radio access system on the basis of a radio coverage map referenced by a mobile station location and a radio access system switching unit adapted to switch to the preferred radio access system for radio communication with the wireless communication environment.

Preferably, in the mobile station according to the fourth aspect of the present invention the second radio access system determining unit is adapted to determine the preferred radio access system upon change of radio availability at the mobile station.

Preferably, the mobile station according to the fourth aspect of the present invention comprises a radio availability detection unit adapted to detect the change of radio availability at the mobile station through drop in signal strength of a radio signal or through change of the types of radio signals receivable at the mobile station.

Preferably, the mobile station according to the fourth aspect of the present invention comprises a radio coverage map download and storage unit adapted to download the radio coverage map from the wireless communication environment to the mobile station.

Preferably, in the mobile station according to the fourth aspect of the present invention the radio coverage map download and storage unit is adapted to download and store the radio coverage map from the wireless communication environment in a push type manner according to at least one predetermined operative condition or in a pull type manner upon request from the mobile station.

Preferably, in the mobile station according to the fourth aspect of the present invention the radio coverage map download and storage unit is adapted to download and store the radio coverage map from the wireless communication environment with respect to a sub-area of the radio coverage area of the wireless communication environment.

In should be mentioned that according to another fifth aspect of the present invention there is provided a computer program product directly loadable into the internal memory of a radio access control node or a mobile station comprising software code portions for performing the inventive radio access system selection process when the product is run on a processor of the radio access control node or a mobile station.

Therefore, the present invention is also provided to achieve an implementation of the inventive method steps on computer or processor systems. In conclusion, such implementation leads to the provision of computer program products for use with a computer system or more specifically a processor comprised in e.g., a radio access control node or a mobile station. The computer program products are directly loadable into the internal memory of a radio access control node or mobile station and comprise software code portions for performing the steps of one of the methods according to the present invention, when the product is run on a processor of the radio access control node or mobile station.

These programs defining the functions of the present invention can be delivered to a computer/processor in many forms, including, but not limited to information permanently stored on non-writable storage media, e.g., read only memory devices such as ROM or CD ROM discs readable by processors or computer I/O attachments; information stored on writable storage media, i.e. floppy discs and hard drives; or information conveyed to a computer/processor through communication media such as network and/or telephone networks via modems or other interface devices. It should be understood that such media, when carrying processor readable instructions implementing the inventive concept represent alternate embodiments of the present invention.

1-15. (canceled)

16. A method of operating a radio access control station in a wireless communication environment supporting at least two radio access technologies for radio communication with a mobile station, the method comprising:
determining a preferred radio access system based on a radio coverage map referenced by a mobile station location;
notifying the mobile station of the preferred radio access system for communication with the wireless communication environment.

17. The method of claim 16, wherein the determining the preferred radio access system comprises determining the preferred radio access system in response to a change of radio availability at the mobile station.

18. The method of claim 17, further comprising detecting the change of radio availability at the mobile station based on at least one of:
a drop in signal strength of at least one radio communication signal
a drop in signal strength of at least one radio positioning signal;
a change of the type of radio signals receivable at the mobile station.

19. The method of claim 16, wherein the determining the preferred radio access system comprises determining the preferred radio access system based on at least one of:
consideration of different radio coverage areas as reflected by the radio coverage map;
consideration of a user profile reflecting user preferences;
consideration of occupation of the wireless communication environment;
consideration of status of the wireless communication environment.

20. The method of claim 16, further comprising determining the radio coverage map at the radio access control station by:
receiving measurement data and related location information from at least one mobile station indicating signalling strength of at least one of:
radio communication signal at the mobile station;
signalling strength of a positioning radio signal at the mobile station;
qualifying the received measurement data according to predetermined criteria.

21. The method of claim 20, wherein the qualifying the received measurement data is based on receipt of multiple reports with respect to the same location in the wireless communication environment.

22. The method of claim 20, wherein the measurement data is generated in response to a request by the radio access control station.

23. A method of operating a mobile station for radio communication with a wireless communication environment supporting at least two radio access technologies, the method comprising:
determining a preferred radio access system based on a radio coverage map referenced by a mobile station location;
switching to the preferred radio access system for radio communication with the wireless communication environment.

24. The method of claim 23, wherein the determining the preferred radio access system comprises determining the preferred radio access system in response to a change of radio availability at the mobile station.

25. The method of claim 23, further comprising detecting the change of radio availability at the mobile station based on a drop in signal strength of a radio signal or through change of the types of radio signals receivable at the mobile station.

26. The method of claim 23, further comprising downloading the radio coverage map from the wireless communication environment to the mobile station.

27. The method of claim 26, wherein the downloading the radio coverage map is executed in one of:
a push type manner according to at least one predetermined operative condition;
a pull type manner upon request from the mobile station.

28. The method of claim 26 wherein the radio coverage map covers a sub-area of the radio coverage area of the wireless communication environment.

29. A radio access control station, operated in a wireless communication environment supporting at least two radio access technologies for radio communication with a mobile station, comprising:
a first radio access system determining unit configured to determine a preferred radio access system based on a radio coverage map referenced by a mobile station location;
a radio access system notifying unit configured to notify the mobile terminal of the preferred radio access system for communication with the wireless communication environment.

30. A mobile station for executing radio communication with a wireless communication environment supporting at least two radio access technologies, the mobile station comprising:
a radio access system determining unit configured to determine a preferred radio access system based on a radio coverage map referenced by a mobile station location; and
a radio access system switching unit configured to switch to the preferred radio access system for radio communication with the wireless communication environment.
